(19) United States
(12) Patent Application Publication
(10) Pub. No.: US 2026/0301092 A1
(43) Pub. Date: Oct. 1, 2026

(54) DYNAMIC COLLEGE PATH PROJECTOR SYSTEM AND METHOD FOR AI-POWERED, MULTI-YEAR PERSONALIZED COLLEGE ADMISSIONS ROADMAP GENERATION

(71) Applicant: EduPolaris AI Corporation, Pasadena, CA (US)

(72) Inventor: Jun Han, Pasadena, CA (US)

(21) Appl. No.: 19/578,318

(22) Filed: Mar. 25, 2026

Related U.S. Application Data
(60) Provisional application No. 63/778,044, filed on Mar. 26, 2025.
(60) Provisional application No. 63/778,035, filed on Mar. 26, 2025.

(51) Int. Cl. G06Q 50/20

(52) U.S. Cl. CPC G06Q 50/205

(57) ABSTRACT

An AI-powered platform and method for generating and updating a personalized multi-year college admissions roadmap is disclosed. The platform ingests a structured student data profile, and retrieves one or more target college data profiles comprising historical admissions statistics and college-specific weighting parameters. For each target college, an Admissions Strength Index (ASI) is computed; a structured gap map is produced quantifying developmental shortfalls; and a plurality of candidate action-item pathways are generated—each accompanied by an admissions probability computed by a multi-tier ensemble of logistic regression, random forest, neural network, and LLM components. One pathway is selected and optimized for workload balance via AI-assisted constraint satisfaction. The platform monitors student progress, recomputes the ASI and admissions probability upon ingestion of new data profile inputs, updates the roadmap, and dispatches AI-generated automated alerts. If projected admissions probability falls below a configurable threshold, the platform performs AI-powered comparative analysis and recommends alternative colleges.

### CROSS-REFERENCE TO RELATED APPLICATIONS

This application claims priority to U.S. Provisional Patent Application No. 63/778,044, filed Mar. 26, 2025, and U.S. Provisional Patent Application No. 63/778,035 filed Mar. 26, 2025, the contents of both of which are fully incorporated by reference herein in their entirety.

### FIELD OF THE INVENTION

The present invention relates to artificial intelligence (AI)-powered platforms and data-intelligence systems for personalized educational planning, and more particularly to a large-language model (LLM) and machine-learning platform that generates dynamic, multi-year college admissions roadmaps by continuously evaluating a student's academic and extracurricular profile against target college admission criteria, computing a proprietary Admissions Strength Index (ASI), identifying developmental gaps, and producing adaptively updated action plans and timelines to maximize a student's probability of admission to their desired colleges.

### BACKGROUND

The college admissions process in the United States and globally has grown increasingly competitive and complex. Top-tier universities regularly receive tens of thousands of applications for a limited number of seats, and the criteria used to evaluate applicants extend well beyond academic transcripts to include extracurricular achievements, leadership experiences, standardized test performance, personal essays, letters of recommendation, demonstrated interest in a chosen major, and financial need. A student's path to college admission therefore requires years of deliberate preparation, beginning as early as ninth grade.

Existing approaches to college counseling suffer from several significant limitations. First, traditional human counselors have finite bandwidth and typically serve large caseloads, limiting the depth and frequency of personalized guidance. Second, off-the-shelf college planning tools-such as static checklists, generalized timelines, and college search engines-do not adapt to the individual student's evolving profile or provide quantitative assessments of admissions likelihood. Third, the gap between a student's current profile and the profile of a typical admitted student at a target institution is rarely communicated in a structured, actionable manner. Fourth, no existing commercially available platform integrates historical admissions data, machine learning (ML)-based prediction, a modular task management framework, and real-time dynamic updating into a single cohesive system. Fifth, no existing tool provides quantitative, machine-learning-derived admissions probability estimates that are directly tied to specific task completion, nor a mechanism for automatic alternative college suggestion when a student's likelihood of admission falls below a meaningful threshold.

What is needed is an AI-powered platform and method that: (a) continuously ingests and processes a student's profile data across multiple developmental dimensions; (b) computes a college-specific, quantitative admissions strength score; (c) identifies precise gaps between the student's current profile and target college expectations; (d) generates prioritized, AI-powered action plans organized by module and timeline; (e) dynamically updates the plan as the student progresses; and (f) proactively recommends alternative pathways when the student's projected admissions likelihood falls below an acceptable threshold.

The present invention addresses these needs through the Dynamic College Path Projector™ (DCPP), an AI-powered platform that overcomes the foregoing deficiencies in the prior art.

### SUMMARY

In one aspect, an AI-powered platform is disclosed for generating and dynamically updating a personalized multi-year college admissions roadmap for a student, the platform comprising a cloud-hosted LLM and data computation system configured to perform operations including: (a) ingesting and maintaining a structured student data profile comprising academic data, extracurricular data, honors and awards data, financial data, and personal information; (b) retrieving one or more target college data profiles comprising admission requirements, historical admission statistics, and college-specific weighting parameters; (c) computing, for each target college, an Admissions Strength Index (ASI) by applying a weighted, LLM-and-machine-learning-based composite scoring function to the student data profile and the target college data profile; (d) identifying developmental gaps between the student data profile and the target college data profile across six predefined modules; (e) generating, via a LLM recommendation engine, a plurality of candidate action-item pathways at varying difficulty levels with corresponding projected admissions probabilities; (f) constructing a multi-year dynamic roadmap comprising tasks, milestones, timelines, and priority rankings; (g) monitoring student progress and updating the roadmap in real time upon ingestion of new profile data; and (h) recommending alternative colleges when the projected admissions probability for a target college falls below a configurable threshold.

In another aspect, an AI-powered method is disclosed for generating a personalized college admissions roadmap, comprising corresponding data-processing and AI-inference steps performed by the platform described above.

In a further aspect, a cloud-hosted data and AI computation environment is disclosed whose deployed software services, when executed, implement the platform and method described herein.

These and other aspects, features, and advantages of the invention will become apparent from the following detailed description, taken together with the accompanying drawings.

### BRIEF DESCRIPTION OF THE DRAWINGS

The accompanying drawings, which are incorporated in and constitute a part of this specification, illustrate embodiments of the invention and together with the description serve to explain the principles of the invention.

FIG. 1 is a high-level system architecture diagram illustrating the major components of the Dynamic College Path Projector™ system, showing the five primary subsystems, the API layer, and the data store.

FIG. 2 is a flowchart illustrating the overall method for generating a personalized college admissions roadmap according to Steps 1 through 11 of the algorithm.

FIG. 3 is a schematic diagram illustrating computation of the Admissions Strength Index (ASI) across six weighted sub-dimensions and the machine-learning model ensemble.

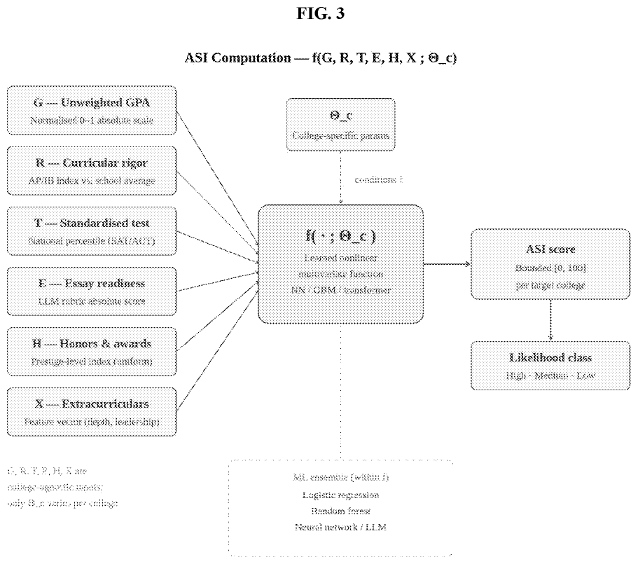

FIG. 4 is a flowchart illustrating the alternative college recommendation procedure of Step 11, including the student decision branch and platform reconfiguration path.

FIG. 5 illustrates an exemplary computer that can be used to perform the methods and steps described herein.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to those skilled in the art, and the general principles defined herein may be applied to other embodiments and applications without departing from the scope of the invention.

### I. Overview and System Architecture

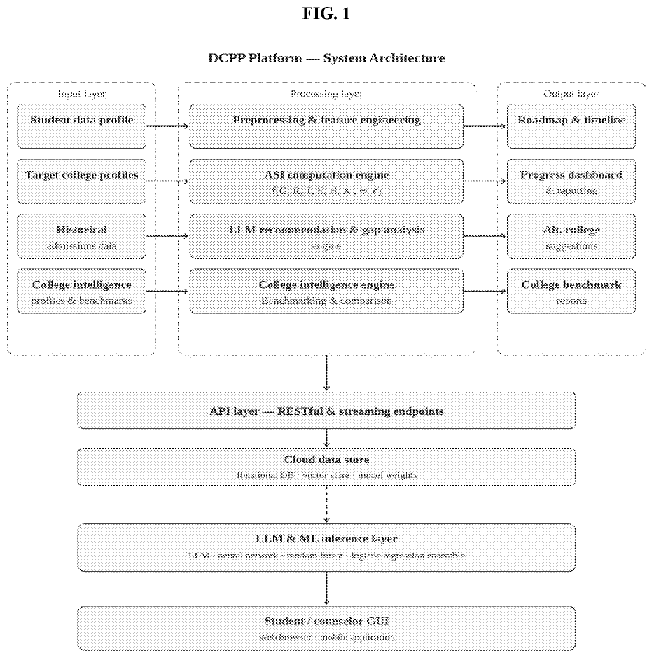

The Dynamic College Path Projector™ (DCPP) is an AI-powered, cloud-native data platform designed to deliver personalized, continuously updated college admissions planning to high school students. Referring to FIG. 1, the DCPP platform comprises five primary subsystems: (1) a Data Ingestion and Storage Module; (2) a Preprocessing and Feature Engineering Engine; (3) an Admissions Strength Index (ASI) Computation Engine; (4) an AI Recommendation and Gap Analysis Engine; and (5) a Roadmap Generation, Timeline, and Reporting Module. These subsystems communicate via an Application Programming Interface (API) layer and persist state in a cloud-hosted relational database, vector store, or document-oriented data store.

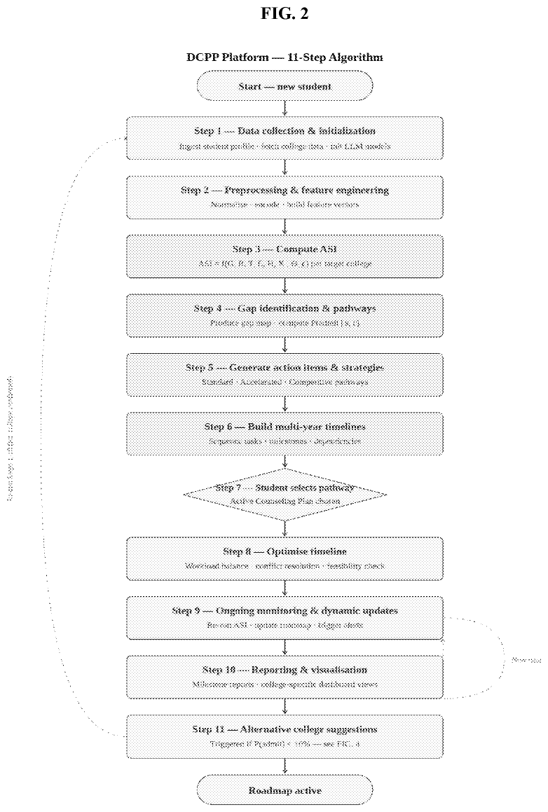

The System operates through an eleven-step algorithm described in detail below and illustrated in FIG. 2. Each step produces defined outputs that serve as inputs to subsequent steps, and multiple steps may be re-executed when triggered by new data or user actions (see Step 9 and Step 11). In preferred embodiments, the platform is deployed as a cloud-hosted, API-first software-as-a-service (SaaS) application accessible via web browser and mobile application, leveraging scalable cloud inference infrastructure for real-time LLM and ML model execution. The student (or an authorized counselor) interacts with the platform through a responsive graphical user interface (GUI) that renders roadmaps, timelines, progress dashboards, and notification alerts.

### II. Input Data Sources

The System ingests data from four primary input sources:

### A. Student Profile.

The student profile is the foundational data object of the DCPP platform. It is populated via a structured onboarding interview presented to the student or counselor through the GUI, and thereafter updated continuously as the student logs new achievements. The student profile comprises:
Personal information: name, current grade level (9th through 12th), high school name, geographic location, and demographic data (optional, used for context only).
Academic data: unweighted and weighted GPA; class rank (if reported); course-by-course transcript including subject area, grade received, and course level (regular, honors, AP, IB, dual enrollment, or college-level); AP and IB exam scores; SAT and/or ACT composite and section scores; and projected future coursework.
Extracurricular data: a structured record of each activity including category (athletics, performing arts, community service, academic clubs, research, internship, entrepreneurship, etc.), role and leadership level, weekly hours committed, weeks per year active, years of participation, and notable achievements within the activity.
Honors and awards: competition names, levels (school, regional, state, national, international), placement (participant, finalist, winner), and year received.
Financial data: estimated family contribution (EFC), FAFSA filing status, and financial need designation (optional).
Preferred colleges and intended majors: a ranked list of target colleges and one or more intended areas of study, which anchor the gap analysis and roadmap generation.

### B. Target College Profiles.

For each college on the student's target list, the system retrieves or stores a college profile comprising:
Admissions statistics: acceptance rate, middle-50% GPA range, middle-50% SAT/ACT range, percentage of admitted students reporting class rank, and typical extracurricular profiles of admitted students.
College-specific weighting parameters: the relative importance assigned by the institution to academic metrics, extracurricular achievement, essays, recommendations, demonstrated interest, and other qualitative factors, based on publicly available Common Data Set (CDS) disclosures and admissions expert insights.
Historical admissions data: aggregated outcomes from prior applicant cohorts (where available), used to train and validate the ML prediction models.
Scholarship and financial aid profiles: available institutional merit and need-based scholarships, FAFSA requirements, and average financial aid awards.

### C. Admissions Strength Index (ASI).

The ASI is a proprietary composite score computed by the ASI Computation Engine via a LLM and machine learning inference pipeline. The ASI is defined as a learned nonlinear multivariate function f(G, R, T, E, H, X; Θ_c), where G, R, T, E, H, and X are six fully independent input variables each measuring a distinct dimension of the student's profile on an absolute, college-agnostic scale, and Θ_c is a college-specific parameter vector that conditions the function on the target college without altering the input variable definitions. The six independent input dimensions are: (1) Unweighted GPA (G); (2) Curricular Rigor (R); (3) Standardized Test scores (T); (4) Essay Readiness & Quality (E); (5) Honors and Awards (H); and (6) Extracurricular Activities (X). The formal ASI computation is described below.

### D. Historical Admissions Data.

The System is trained on and informed by aggregated, anonymized data from past applicants, including application profiles, college decisions, and enrollment outcomes. This data corpus is used to train the ML model ensemble and to calibrate the ASI weighting scheme.

### III. The Six-Module Framework

All gap analysis, action-item generation, and roadmap construction in the DCPP system are organized around six predefined developmental modules, as summarized in the table below. All modules are approached in the context of particular high schools. This modular architecture ensures comprehensive coverage of all components evaluated in the college admissions process.

| # | Module Name | Scope of Coverage |
|---|---|---|
| 1 | Academics | GPA management, course selection, standardized test |
| | | preparation, AP/IB exam performance, courses taken |
| | | outside high schools. |
| 2 | Extracurricular | Club participation, sports, community service, research, |
| | Activities | internships, leadership development, and etc. |
| 3 | Major | Alignment of declared major interest with coursework, |
| | Selection | activities, and college program requirements. |
| | | Competitiveness of selected major(s). |
| 4 | Honors/ | Competitions, science fairs, arts awards, national |
| | Awards | recognition programs conference participation, and etc. |
| 5 | Application | Personal statements, supplemental essays, letters of |
| | Materials | recommendation, activity list, honors. |
| 6 | Financial | FAFSA preparation, scholarships curation, financial |
| | Aid/ | aid application strategy, and EFC management. |
| | Scholarships | |

### IV. Step 1—Data Collection and Initialization

Upon platform initialization for a new student, the Data Ingestion and Storage Module executes a structured data ingestion sequence. The system presents an onboarding workflow that solicits: (i) the student's current grade level and intended graduation year; (ii) a ranked list of target colleges and intended majors; (iii) academic credentials including all available GPA records, class rank, standardized test scores, AP/IB scores, and projected future coursework; (iv) extracurricular involvement structured by the categories enumerated herein; and (v) any honors, awards, or distinctions received.

Concurrently, the platform fetches or retrieves from its data store the corresponding college profiles for each target institution, including current-cycle admissions statistics from the Common Data Set and any proprietary historical admissions data maintained by the platform. The LLM and ML model subsystem is initialized with pre-trained model weights and fine-tuned embeddings derived from historical admissions outcomes across comparable student cohorts. The output of Step 1 is a consolidated data object containing all student attributes, target college data profiles, and relevant historical benchmarks required for subsequent AI-powered processing.

### V. Step 2—Preprocessing and Feature Engineering

Raw student profile data is processed by the Preprocessing and Feature Engineering Engine before being passed to the LLM and ML inference pipeline. This step comprises three sub-processes:
(a) Data Cleansing: GPA values are normalized to an unweighted 4.0 scale. Standardized test scores are converted to percentile equivalents. Extracurricular activity entries are standardized using a controlled vocabulary taxonomy for activity type, leadership role, and commitment level. Missing values are imputed using population-level defaults or flagged for user completion.
(b) Feature Construction: Extracurricular activities are encoded as multi-dimensional feature vectors capturing intensity (hours per week×weeks per year), leadership ordinal level (1-5, from participant to national leader/founder), duration (years), and categorical domain. Academic features include course rigor indices computed from the distribution of AP/IB and honors courses relative to those available at the student's school.
(c) Normalization and Encoding: All continuous features are scaled (e.g., min-max normalization or z-score standardization) to ensure compatibility with the ML models. Categorical features (e.g., activity type, major family, geographic region) are one-hot encoded or embedded using learned representations.

The output of Step 2 is a refined, normalized feature dataset ready for ASI computation and LLM model inference.

### VI. Step 3—Admissions Strength Index (ASI) Computation

The Admissions Strength Index (ASI) is a proprietary composite score computed by the ASI Computation Engine. The ASI quantifies the degree to which the student's current profile aligns with the expected profile of an admitted student at each target college.

Formally, the ASI is computed as a multivariate function of six independent input variables, conditioned on college-specific parameters:

$$ASI = f ( G , R , T , E , H , X ; Θ\_c )$$

where:
G(s,c)=normalized academic GPA sub-score for student s relative to college c's admitted cohort and in the context of student's high school;
R(s,c)=curricular rigor sub-score, reflecting the quality and challenge level of the student's course selection and in the context of student's high school;
T(s,c)=standardized test sub-score (SAT/ACT percentile relative to college c's middle-50% range);
E=independent input variable representing essay readiness and quality, assessed via an LLM rubric applied to submitted drafts or proxy estimates derived from writing samples, scored on a fixed absolute scale;
H=independent input variable representing honors and awards achievement, computed from a standardized prestige-and-level index applied uniformly across all colleges;
X=independent input variable representing extracurricular activities, capturing depth, leadership, consistency, and relevance to the intended major, encoded as a fixed multi-dimensional feature vector;
α₁ through α₆=college-specific weighting parameters derived from the target college's disclosed admissions priorities and calibrated via ML training on historical admissions data; and
f(·; Θ_c)=a learned nonlinear multivariate function (e.g., a neural network, gradient-boosted model, or transformer layer) that maps the six independent input variables (G, R, T, E, H, X) to a bounded ASI score in the range [0, 100], conditioned on the college-specific parameter vector Θ_c. Because the input variables are each defined independently of any specific college, the same values of G, R, T, E, H, and X can be evaluated under different Θ_c vectors to produce directly comparable ASI scores across multiple target colleges.

The ASI is computed independently for each target college by evaluating f(G, R, T, E, H, X; Θ_c) with the corresponding college-specific parameter vector Θ_c, while holding the six input variables constant across all colleges. This architecture enables direct comparison of a student's standing across multiple target colleges without recomputing the underlying input variables. The ASI is persisted in the platform's data store and recalculated each time the student data profile is updated. The output of Step 3 is a set of ASI scores and categorical likelihood classifications (High, Medium, or Low), one per target college.

### VII. Step 4—Gap Identification and Potential Pathways

The Gap Identification sub-module of the AI Recommendation Engine compares the student's current profile against the target college's expected profile across all six modules to produce a structured “gap map.” For each module, the gap map specifies:
The current value of the student's relevant metrics;
The target range or expected value for admitted students at the target college;
The magnitude of the gap (expressed as a percentile delta, score delta, or qualitative rating); and
The relative priority of closing the gap, based on its contribution to the ASI and the student's current grade level.

The LLM and ML model subsystem-comprising an ensemble of logistic regression, random forest, neural network, and large language model (LLM) components-ingests the preprocessed feature vector and outputs a real-valued admissions probability P(admit|s, c)∈[0, 1] for each target college. This probability, together with the gap map, informs the generation of action items in Step 5. The output of Step 4 is a structured gap map identifying all areas requiring development, organized by module, with associated impact estimates.

### VIII. Step 5—Generate Action Items and Strategies

For each identified gap, the LLM Recommendation Engine queries a curated strategy knowledge base and applies LLM-based reasoning to retrieve and synthesize candidate action items. Action items are organized hierarchically:
Large Tasks: multi-month initiatives (e.g., “enroll in AP Chemistry,” “establish and lead a STEM club,” “complete an independent research project”);
Sub-Tasks: weekly or monthly activities supporting a large task (e.g., “complete two AP Chemistry practice tests per month,” “attend club recruitment fair”); and
One-time milestones: specific events with fixed deadlines (e.g., “register for the SAT by [date],” “submit competition application by [date]”).

The system generates candidate action-item pathways corresponding to three difficulty levels-Standard, Accelerated, and Competitive—each representing a different trade-off between the level of effort required and the projected improvement in admissions probability. For each pathway, the LLM and ML inference layer recomputes P(admit|s, c) under the assumption that all recommended tasks are completed successfully, yielding three projected admissions probabilities to present to the student. The System ranks all tasks by expected impact on the student's ASI, and the user may filter recommendations by feasibility parameters including weekly time availability and budget.

### IX. Step 6—Build an Initial Multi-Year Timeline

The Roadmap Generation Module constructs a structured multi-year timeline for each of the three candidate pathways. Task sequencing accounts for prerequisite dependencies (e.g., Algebra II must precede AP Calculus), external fixed deadlines (e.g., standardized test dates, competition registration windows, early decision application deadlines), and the student's current academic schedule and workload capacity.

The timeline is rendered in the GUI as a Gantt-chart-style visualization organized by academic year and semester, showing each task's name, start date, expected completion date, expected impact level (High/Medium/Low), and module category. A complementary calendar view allows day-level scheduling of sub-tasks and milestone reminders. The output of Step 6 is three complete multi-year timelines, one per projected path, with tasks mapped by priority, dependency, and semester/year.

### X. Step 7—Student Pathway Selection

The student (or counselor) reviews the three candidate pathways-Standard, Accelerated, and Competitive—each accompanied by a projected admissions probability, a summary of required effort, and key differentiating action items. The student selects one pathway as their active Counseling Plan. The selected pathway is stored as the primary roadmap and all subsequent monitoring and updates in Steps 8 through 11 operate on this selected plan.

### XI. Step 8—Timeline Optimization

After the student selects a pathway, a constraint satisfaction optimization algorithm refines the timeline to ensure workload balance. The optimization sub-module applies the following constraints: (i) no more than a configurable maximum number of high-intensity tasks overlap within any two-week window; (ii) academic tasks are not scheduled during school exam periods unless marked as low-intensity; and (iii) all task deadlines remain feasible given the student's available hours per week as declared during onboarding.

If scheduling conflicts are detected, the platform proposes alternative task orderings or timing shifts, which the student can accept or manually override through the GUI's drag-and-drop task manager interface. The output of Step 8 is a refined, optimized Counseling Plan that balances academic, extracurricular, application, and personal constraints.

### XII. Step 9—Ongoing Monitoring and Dynamic Updates

Step 9 comprises a continuous, event-driven monitoring loop that maintains alignment between the student's evolving profile and the active Counseling Plan. The monitoring process includes:
A. Progress Tracking. The student or counselor updates task completion status (completed, in-progress, delayed). The System records GPA updates, new honors, new extracurricular activities, updated test scores, and other profile changes as they occur.
B. Real-Time Profile Re-evaluation. Upon each significant data update, the platform re-runs the full data preprocessing pipeline, recomputes the ASI and P(admit|s, c) for all target colleges via real-time AI inference, recalculates the gap map, and automatically updates the roadmap to remove completed tasks, reprioritize remaining tasks, and add newly recommended tasks. If the student modifies their intended major or adds a new target college, the System re-executes the full planning pipeline from Step 3 onward.
C. Negative Event Triggering. When a critical task failure or setback is logged (e.g., failure to obtain a significant honor, a meaningful test score decline, or expiration of a strategic opportunity window), the System automatically re-runs gap analysis and generates alternative action item recommendations and recalculated probabilities for the affected college(s).
D. Positive Opportunity Triggering. When a new opportunity is identified that would meaningfully improve the student's admission probability (e.g., a newly announced competition aligned with the student's profile), the System proactively surfaces a recommendation and recalculates probabilities.
E. Notifications and Alerts. Push notifications or in-app alerts are dispatched to inform the student of meaningful changes in projected admissions probability, roadmap status, or when any real-time alternative plan suggestions are generated.

### XIII. Step 10—Reporting and Visualization

At configurable intervals (e.g., end of each semester or academic year), the platform generates milestone reports summarizing: (i) tasks completed and tasks remaining; (ii) changes in ASI and projected admissions probability since the last report; (iii) a college-specific view comparing the student's current profile against the admitted-student benchmark for each target college; and (iv) a forward-looking projection of the student's expected profile upon completion of all planned roadmap tasks. All reports and visualizations are accessible through the student's dashboard and may be exported as PDF or shared with a counselor via a role-based access control mechanism.

### XIV. Step 11—Real-Time Alternative College Suggestions

Step 11 is triggered when the student's projected admissions probability P(admit|s, c) for a target college c falls below a configurable threshold-defaulting to 10%. When this condition is met, the platform automatically executes an AI-powered college comparison analysis to identify alternative institutions that: (i) share characteristics with the original target college (e.g., size, location, academic profile, major strength); (ii) have a projected admissions probability above a “Medium” threshold given the student's current and projected profile; and (iii) satisfy the student's stated preferences.

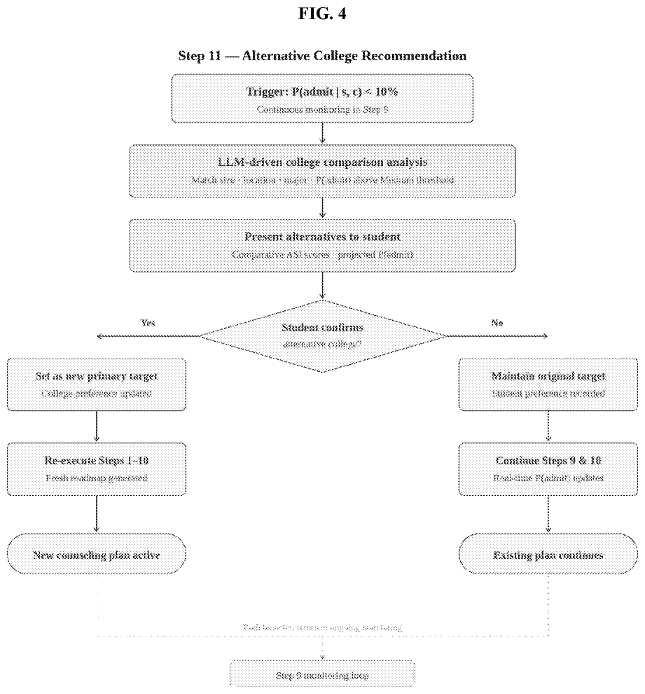

The student is presented with the alternative college suggestions along with comparative ASI scores and projected admissions probabilities. As illustrated in FIG. 4, two decision branches follow: (a) if the student confirms selection of an alternative college, the platform re-executes Steps 1 through 10 for the new target, generating a fresh roadmap anchored to the revised college target; (b) if the student elects to maintain the original target, the platform continues executing Steps 9 and 10 with updated real-time probability estimates.

### XV. Machine Learning Models

In preferred embodiments, the LLM and ML model subsystem employs a multi-tier ensemble approach combining:
Logistic Regression: Provides a fast, interpretable baseline probability estimate and enables identification of the linear contributions of individual features to the admissions probability.
Random Forest: Captures nonlinear feature interactions and provides feature importance rankings that inform the gap analysis and action-item prioritization.
Large Language Model/Transformer (e.g., fine-tuned LLM or multi-layer perceptron): Learns complex, high-dimensional representations of applicant profiles and college-specific admission patterns via deep contextual reasoning, yielding the most accurate probability estimates and enabling natural-language generation of personalized guidance, essay feedback, and narrative action-item explanations.

The ensemble output is a weighted aggregation of all model probability estimates, with weights optimized during training via cross-validation on held-out historical admissions data. Models are continuously monitored and fine-tuned periodically (e.g., annually or upon significant data drift) as new admissions cohort data becomes available, following standard MLOps and LLMOps practices.

### XVI. Deployment and Computational Infrastructure

The DCPP platform is designed for deployment on modern cloud-native infrastructure, comprising: a scalable AI inference layer providing GPU-accelerated and TPU-accelerated compute for real-time LLM and ML model execution; a managed data platform comprising cloud-hosted relational and vector databases for structured student data profiles, college data, model embeddings, and roadmap state; a model serving layer exposing RESTful and streaming API endpoints for LLM inference, ASI computation, and recommendation generation; an event-driven data pipeline for real-time ingestion, transformation, and synchronization of student data profile updates; and a front-end delivery layer rendering the GUI on client devices including desktop browsers and mobile applications.

In cloud-hosted deployments, the platform is containerized (e.g., using Docker/Kubernetes or a managed cloud AI platform such as AWS SageMaker, Google Vertex AI, or Microsoft Azure AI) and deployed across geographically distributed cloud regions to ensure low-latency AI inference and high availability. All student data is encrypted at rest and in transit in compliance with applicable data privacy regulations including FERPA, COPPA, NDPA, and GDPR. The platform supports multi-user access, enabling individual students, parents, and counselors to interact with a shared student data profile subject to role-based access controls. Counselors may serve multiple students simultaneously, each with an independent active Counseling Plan.

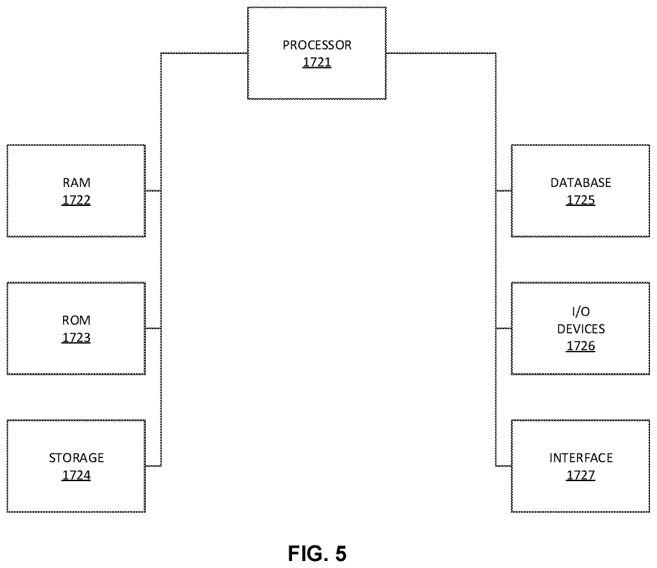

The above-described methods may be implemented on a computing system. The system has been described above as comprised of units. One skilled in the art will appreciate that this is a functional description and that the respective functions can be performed by software, hardware, or a combination of software and hardware. A unit can be software, hardware, or a combination of software and hardware. In one exemplary aspect, the units can comprise a computing device that comprises a processor 1721 as illustrated in FIG. 5 and described below.

FIG. 5 illustrates an exemplary computer that can be used to perform the methods and steps described herein. As used herein, “computer” may include a plurality of computers. The computers may include one or more hardware components such as, for example, a processor 1721, a random access memory (RAM) module 1722, a read-only memory (ROM) module 1723, a storage 1724, a database 1725, one or more input/output (I/O) devices 1726, and an interface 1727.

All of the hardware components listed above may not be necessary to practice the methods described herein. Alternatively and/or additionally, the computer may include one or more software components such as, for example, a computer-readable medium including computer executable instructions for performing a method associated with the exemplary embodiments. It is contemplated that one or more of the hardware components listed above may be implemented using software. For example, storage 1724 may include a software partition associated with one or more other hardware components. It is understood that the components listed above are exemplary only and not intended to be limiting.

Processor 1721 may include one or more processors, each configured to execute instructions and process data to perform one or more functions associated with a computer for discriminating tissue of a specimen. Processor 1721 may be communicatively coupled to RAM 1722, ROM 1723, storage 1724, database 1725, I/O devices 1726, and interface 1727. Processor 1721 may be configured to execute sequences of computer program instructions to perform various processes. The computer program instructions may be loaded into RAM 1722 for execution by processor 1721.

RAM 1722 and ROM 1723 may each include one or more devices for storing information associated with operation of processor 1721. For example, ROM 423 may include a memory device configured to access and store information associated with the computer, including information for identifying, initializing, and monitoring the operation of one or more components and subsystems. RAM 1722 may include a memory device for storing data associated with one or more operations of processor 1721. For example, ROM 1723 may load instructions into RAM 1722 for execution by processor 1721.

Storage 1724 may include any type of mass storage device configured to store information that processor 1721 may need to perform processes consistent with the disclosed embodiments. For example, storage 1724 may include one or more magnetic and/or optical disk devices, such as hard drives, CD-ROMs, DVD-ROMs, or any other type of mass media device.

Database 1725 may include one or more software and/or hardware components that cooperate to store, organize, sort, filter, and/or arrange data used by the computer and/or processor 1721. For example, database 1725 may store raw data, as described herein and computer-executable instructions for performing the disclosed steps. It is contemplated that database 1725 may store additional and/or different information than that listed above.

I/O devices 1726 may include one or more components configured to communicate information with a user associated with computer. For example, I/O devices may include a console with an integrated keyboard and mouse to allow a user to maintain a database of digital images, results of the analysis of the digital images, metrics, and the like. I/O devices 1726 may also include a display including a graphical user interface (GUI) for outputting information on a monitor. I/O devices 1726 may also include peripheral devices such as, for example, a printer for printing information associated with the computer, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 1727 may include one or more components configured to transmit and receive data via a communication network, such as the Internet, a local area network, a workstation peer-to-peer network, a direct link network, a wireless network, or any other suitable communication platform. For example, interface 1727 may include one or more modulators, demodulators, multiplexers, demultiplexers, network communication devices, wireless devices, antennas, modems, and any other type of device configured to enable data communication via a communication network.

### XVII. Alternatives and Modifications

While the foregoing description sets forth preferred embodiments of the invention, those skilled in the art will appreciate that numerous modifications and variations are possible within the scope of the appended claims. For example:
The six-module framework may be expanded or contracted to include additional or fewer developmental domains.
The ASI formula may incorporate additional sub-scores (e.g., interview performance, demonstrated interest metrics, socioeconomic context adjustments) without departing from the scope of the invention.
The LLM layer may be upgraded to incorporate larger or more capable foundation models (e.g., GPT-class or open-source LLMs) for richer natural-language understanding of essays, recommendation letters, and application materials, as well as for generating personalized narrative guidance.
The threshold for alternative college suggestions (default: 10% projected admissions probability) is configurable by system administrators or individual users.
The system may be integrated with third-party platforms including learning management systems (LMS), SAT/ACT preparation services, and college application portals (e.g., Common App, Coalition App).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain.

What is claimed is:

1. An AI-powered platform for generating a personalized multi-year college admissions roadmap for a student, the platform comprising:
a cloud-hosted LLM and data computation system configured to perform operations comprising: ingesting a structured student data profile comprising academic data including grade point average (GPA), course enrollment data, and standardized test scores; extracurricular data including activity type, duration, leadership level, and time commitment; and honors and awards data, wherein the AI-powered platform is configured for:
retrieving, for each of one or more target colleges, a target college data profile comprising admission statistics and college-specific weighting parameters for a plurality of admissions criteria;
computing, for each target college, an Admissions Strength Index (ASI) by applying a weighted composite scoring function-implemented via a LLM and machine learning inference layer—to the student data profile and the target college data profile across at least six predefined modules comprising (i) academics, (ii) extracurricular activities, (iii) major selection, (iv) honors and awards, (v) application materials, and (vi) financial aid and scholarships;
identifying, via an AI gap analysis engine, developmental gaps between the student data profile and the target college data profile for each of the six predefined modules;
generating, via a LLM recommendation engine, a plurality of action-item pathways at a plurality of difficulty levels, each pathway comprising a set of recommended tasks and a projected admissions probability computed by a machine learning model;
constructing a multi-year dynamic roadmap comprising the recommended tasks, associated timelines, milestones, and priority rankings; and
updating the multi-year dynamic roadmap in response to ingestion of updated student data profile inputs.

2. The platform of claim 1, wherein computing the ASI comprises computing: ASI=f (G, R, T, E, H, X; Θ_c), wherein G, R, T, E, H, and X are fully independent scalar sub-scores each defined on a fixed, college-agnostic scale representing, respectively: (G) normalized unweighted GPA; (R) curricular rigor; (T) standardized test performance expressed as a national percentile; (E) LLM-assessed essay readiness and quality; (H) honors and awards achievement; and (X) extracurricular activity depth and leadership; wherein α₁ through α₆ are college-specific weighting coefficients that are the sole carriers of college-dependency, calibrated per target college via ML training on historical admissions data; and wherein f(·) is a nonlinear transformation function mapping the weighted sum to a bounded ASI score in the range [0, 100].

3. The platform of claim 1, wherein the LLM and machine learning model layer comprises an ensemble of at least a logistic regression model, a random forest model, a neural network model, and a large language model (LLM) component, and wherein the projected admissions probability is a weighted aggregation of probability estimates output by each model in the ensemble.

4. The platform of claim 1, wherein the operations further comprise: presenting the plurality of action-item pathways to the student, wherein each pathway corresponds to a respective difficulty level selected from Standard, Accelerated, and Competitive; receiving a student selection of one pathway as an active Counseling Plan; and optimizing the multi-year dynamic roadmap for the selected pathway by applying AI-assisted constraint satisfaction to balance student workload and resolve scheduling conflicts.

5. The platform of claim 1, wherein updating the multi-year dynamic roadmap comprises: re-executing the data preprocessing and feature engineering pipeline on the updated student data profile; recomputing the ASI and the projected admissions probability for each target college via real-time AI inference; recalculating the developmental gap map across all six predefined modules; and dispatching a notification to the student identifying changes in projected admissions probability or roadmap status.

6. The platform of claim 1, wherein the operations further comprise: determining that the projected admissions probability for a target college has fallen below a configurable threshold; executing a college comparison analysis to identify one or more alternative colleges satisfying the student's stated preferences and having a projected admissions probability above a second threshold; and presenting the one or more alternative colleges to the student with comparative ASI scores and projected admissions probabilities.

7. The platform of claim 6, wherein, upon the student confirming selection of an alternative college, the operations further comprise re-executing all data collection, preprocessing, ASI computation, gap identification, action-item generation, roadmap construction, and timeline optimization operations for the alternative college.

8. The platform of claim 1, wherein the multi-year dynamic roadmap is rendered in a graphical user interface as a Gantt-chart visualization organized by academic year and semester, each task displayed with a start date, an expected completion date, an expected impact level, and a module category.

9. The platform of claim 1, wherein identifying developmental gaps further comprises generating a gap map specifying, for each of the six predefined modules: a current metric value from the student profile; a target metric range from the target college profile; a gap magnitude expressed as at least one of a percentile delta, a score delta, or a qualitative rating; and a gap priority ranking based on the gap's contribution to the ASI.

10. The platform of claim 1, wherein the operations further comprise: detecting occurrence of a negative triggering event comprising at least one of: failure to obtain a critical honor, a meaningful decline in standardized test scores, or a significant delay in a critical task; and in response, re-executing AI-powered gap analysis and generating alternative action item recommendations with recalculated admission probabilities.

11. The platform of claim 1, wherein the operations further comprise: detecting occurrence of a positive triggering event comprising identification of a new opportunity predicted to meaningfully improve the student's admission probability; and in response, generating a proactive recommendation and recalculating admission probabilities.

12. The platform of claim 1, wherein the academic data further comprises Advanced Placement (AP) exam scores, International Baccalaureate (IB) exam scores, class rank, and projected future coursework, and wherein the course enrollment data encodes a curricular rigor index computed from the distribution of AP, IB, honors, and dual enrollment courses relative to courses available at the student's school.

13. The platform of claim 1, wherein the extracurricular data is encoded as a multi-dimensional feature vector comprising at least: an intensity value computed as a product of weekly hours and annual weeks of participation; a leadership ordinal score on a scale from participant to national leader or founder; a duration value in years; and a categorical domain encoding.

14. The platform of claim 1, wherein the student data profile is encrypted at rest and in transit, and wherein access to the student profile is governed by a role-based access control mechanism that permits access by at least one of the student, a designated counselor, and a parent or guardian.

15. The platform of claim 1, wherein the operations are further performable as a computer-implemented method comprising the steps of: ingesting the student data profile; retrieving the target college data profiles; computing the ASI for each target college; identifying developmental gaps across the six predefined modules; generating the plurality of action-item pathways with associated projected admissions probabilities; constructing the multi-year dynamic roadmap; and dynamically updating the roadmap upon ingestion of updated student data profile inputs.

16. A cloud-hosted LLM and data computation platform whose deployed services, when executed, perform operations for generating a personalized multi-year college admissions roadmap, the operations comprising: ingesting a structured student data profile comprising at least academic performance data, extracurricular activity data, and honors and awards data; retrieving, for each of one or more target colleges, a college data profile comprising historical admission data and admission criteria weighting parameters; computing an Admissions Strength Index (ASI) for each target college using a weighted LLM-and-machine-learning-based composite function applied across at least six developmental modules; performing an AI-powered gap analysis comparing the student data profile to each target college data profile to produce a structured gap map specifying, for each module, a current metric value, a target metric range, a gap magnitude, and a priority ranking; generating a plurality of candidate roadmap pathways, each comprising LLM-recommended action items and a machine-learning-computed admissions probability; constructing a multi-year dynamic roadmap based on a student-selected pathway; and continuously updating the roadmap and recomputing admissions probabilities upon ingestion of new student data profile inputs; generating, at periodic intervals, milestone reports summarizing task completion status, changes in ASI, and projected admissions probability trends for each target college; and rendering the multi-year dynamic roadmap as a Gantt-chart visualization with per-task metadata including start date, expected completion date, impact level, and module category.
